(19) United States
(12) Patent Application Publication
(10) Pub. No.: US 2025/0104897 A1
(43) Pub. Date: Mar. 27, 2025

(54) MULTILAYER COIL COMPONENT

(71) Applicant: TDK Corporation, Tokyo (JP)

(72) Inventors: Tsubasa OZAWA, Tokyo (JP); Yohei TADAKI, Tokyo (JP); Takuya NIIBORI, Tokyo (JP); Asuka ISHII, Tokyo (JP); Yuya OSHIMA, Tokyo (JP); Akihiko OIDE, Tokyo (JP)

(73) Assignee: TDK Corporation, Tokyo (JP)

(21) Appl. No.: 18/813,360

(22) Filed: Aug. 23, 2024

(30) Foreign Application Priority Data
Sep. 26, 2023 (JP) 2023-163134

(51) Int. Cl. H01F 17/00; H01F 27/29

(52) U.S. Cl. CPC H01F 17/0013; H01F 27/292

(57) ABSTRACT

A multilayer coil component includes: an element body having a pair of first side surfaces opposite to each other in a first direction and a pair of second side surfaces opposite to each other in a second direction orthogonal to the first direction; and a coil disposed inside the element body and having a coil axis extending in a third direction orthogonal to the first direction and the second direction, in which one of the pair of first side surfaces is a mounting surface, and a ratio of a first gap in the first direction between the coil and the mounting surface to a size of the element body in the first direction is 12 to 30% in a cross section viewed in the third direction.

### CROSS REFERENCE TO RELATED APPLICATIONS

This application claims priority to Japanese Patent Application No. 2023-163134 filed on Sep. 26, 2023, the entire contents of which are incorporated by reference herein.

### TECHNICAL FIELD

The present invention relates to a multilayer coil component.

### BACKGROUND

A multilayer coil component including an element body and a coil disposed inside the element body is known (for example, Japanese Unexamined Patent Publication No. 2012-060049). In Japanese Unexamined Patent Publication No. 2012-060049, the coil has a coil axis extending in a predetermined direction. When viewed in the extending direction of the coil axis, the coil has a right-angled quadrilateral shape.

### SUMMARY

The multilayer coil component having the above configuration is mounted on a mounting substrate in such an arrangement that the coil axis extends along the mounting substrate. The multilayer coil component is mounted with one side surface of the element body as a mounting surface facing the substrate. Here, when the multilayer coil component is mounted on the mounting substrate, there has been a possibility that a crack occurs in the element body due to stress applied to the mounting surface side.

An object of one aspect of the present invention is to provide a multilayer coil component capable of suppressing a crack due to stress at the time of mounting.

A multilayer coil component according to the present invention includes: an element body having a pair of first side surfaces opposite to each other in a first direction and a pair of second side surfaces opposite to each other in a second direction orthogonal to the first direction; and a coil disposed inside the element body and having a coil axis extending in a third direction orthogonal to the first direction and the second direction, in which one of the pair of first side surfaces is a mounting surface, and a ratio of a first gap in the first direction between the coil and the mounting surface to a size of the element body in the first direction is 12 to 30% in a cross section viewed in the third direction.

The multilayer coil component includes the coil disposed inside the element body and having the coil axis extending in the third direction orthogonal to the first direction and the second direction. In addition, one of the pair of first side surfaces opposite to each other in the first direction is the mounting surface. Therefore, the multilayer coil component is mounted in such an arrangement that the coil axis extends along a surface of a mounting substrate. At this time, stress is applied to the mounting surface of the multilayer coil component due to the influence of expansion, contraction, and the like of a conductor layer of the mounting substrate. On the other hand, in the cross section viewed in the third direction, the ratio of the first gap in the first direction between the coil and the mounting surface to the size of the element body in the first direction is 12 to 30%. In this case, a distance for suppressing a crack can be secured between the mounting surface, which is easily distorted by stress, and the coil in the element body. As described above, a crack due to stress at the time of mounting can be suppressed.

In the cross section viewed in the third direction, the first gap may be larger than a second gap in the second direction between the coil and the second side surfaces. In this case, a distance for suppressing a crack can be secured between the mounting surface, which is easily distorted by stress, and the coil in the element body.

The first gap may be 1.2 to 6.0 times the second gap. In this case, a distance for suppressing a crack can be secured between the mounting surface, which is easily distorted by stress, and the coil in the element body.

A surface layer region constituting the mounting surface and an internal region on the inner side of the surface layer region may be formed in a first region between the mounting surface and the coil in the element body, and the surface layer region may have a larger average crystal grain size than the internal region. In this case, the occurrence of a crack on the mounting surface can be suppressed in the surface layer region having a large average crystal grain size. On the other hand, even when a crack occurs on the mounting surface, the internal region having a small average crystal grain size and having pores can suppress the progress of the crack to the inside.

The surface layer region may be 2 to 25% of the first region. In this case, the effect of suppressing the occurrence of a crack on the mounting surface in the surface layer region and the effect of suppressing the progress of the crack in the internal region can be obtained in a well-balanced manner.

A multilayer coil component according to the present invention includes: an element body having a pair of first side surfaces opposite to each other in a first direction and a pair of second side surfaces opposite to each other in a second direction orthogonal to the first direction; and a coil disposed inside the element body and having a coil axis extending in a third direction orthogonal to the first direction and the second direction, in which one of the pair of first side surfaces is a mounting surface, and a first gap in the first direction between the coil and the mounting surface may be larger than a second gap in the second direction between the coil and the second side surface in a cross section viewed in the third direction.

The multilayer coil component includes the coil disposed inside the element body and having the coil axis extending in the third direction orthogonal to the first direction and the second direction. In addition, one of the pair of first side surfaces opposite to each other in the first direction is the mounting surface. Therefore, the multilayer coil component is mounted in such an arrangement that the coil axis extends along a surface of a mounting substrate. At this time, stress is applied to the mounting surface of the multilayer coil component due to the influence of expansion, contraction, and the like of a conductor layer of the mounting substrate. On the other hand, in the cross section viewed in the third direction, the first gap in the first direction between the coil and the mounting surface may be larger than the second gap in the second direction between the coil and the second side surface. In this case, a distance for suppressing a crack can be secured between the mounting surface, which is easily distorted by stress, and the coil in the element body. As described above, a crack due to stress at the time of mounting can be suppressed.

The first gap may be 1.2 to 6.0 times the second gap. In this case, a distance for suppressing a crack can be secured between the mounting surface, which is easily distorted by stress, and the coil in the element body.

According to the present invention, a crack due to stress at the time of mounting can be suppressed.

### BRIEF DESCRIPTION OF THE DRAWINGS

FIG. 1 is a perspective view illustrating a multilayer coil component according to an embodiment;

FIG. 2 is an exploded perspective view illustrating a layer structure of the multilayer coil component illustrated in FIG. 1;

FIG. 3 is a cross-sectional view of a mounting structure when the multilayer coil component is mounted on a mounting substrate;

FIG. 4A is a cross-sectional view taken along line IVa-IVa illustrated in FIG. 3, and FIG. 4B is a cross-sectional view of a multilayer coil component according to a comparative example;

FIG. 5 is an enlarged cross-sectional view of the vicinity of a mounting surface as viewed in the Y-axis direction;

FIGS. 6A to 6C are diagrams for explaining a principle in which a crack may occur at the time of mounting the multilayer coil component;

FIGS. 7A and 7B are photographs of a first region;

FIG. 8 is a graph illustrating an experimental result; and

FIGS. 9A and 9B are cross-sectional views illustrating a multilayer coil component according to a modification.

### DETAILED DESCRIPTION

Hereinafter, preferred embodiments of the present invention will be described in detail with reference to the accompanying drawings. Note that the same or corresponding elements in the description of the drawings are denoted by the same reference signs, and redundant description is omitted.

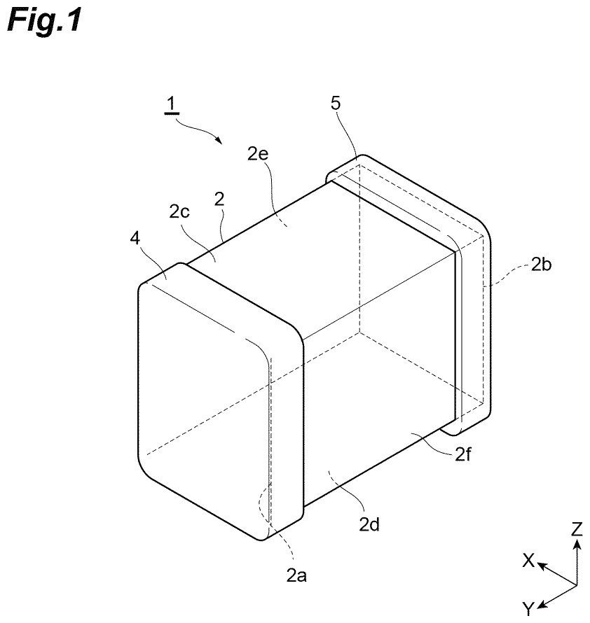

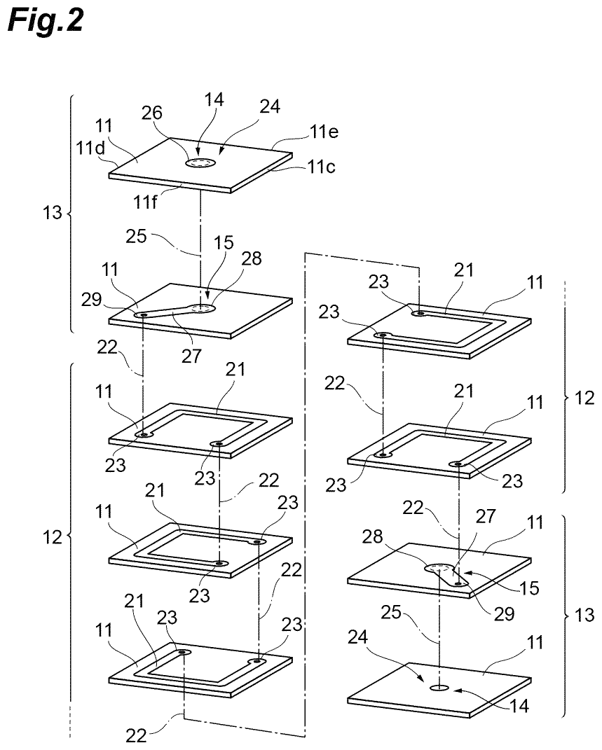

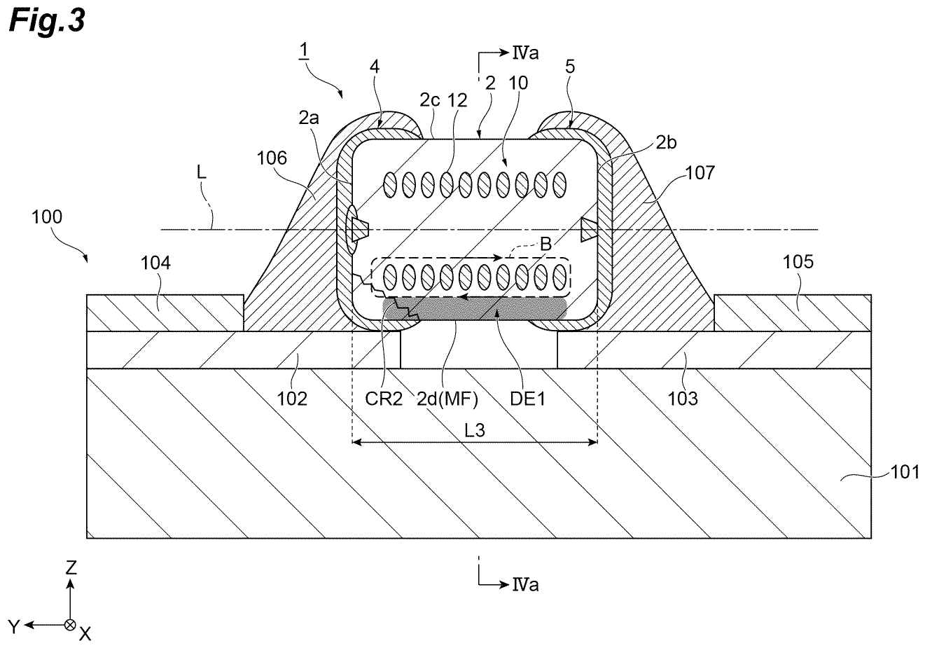

FIG. 1 is a perspective view illustrating a multilayer coil component according to an embodiment. FIG. 2 is an exploded perspective view illustrating a layer structure of the multilayer coil component illustrated in FIG. 1. FIG. 3 is a cross-sectional view of a mounting structure when the multilayer coil component is mounted on a mounting substrate.

As illustrated in FIG. 1, a multilayer coil component 1 includes an element body 2 having a substantially rectangular parallelepiped shape and a pair of external electrodes 4 and 5 disposed at both end portions of the element body 2. The element body 2 has, as outer surfaces, a pair of end surfaces 2a and 2b opposite to each other, and four side surfaces 2c, 2d, 2e, and 2f extending along a direction in which the pair of end surfaces 2a and 2b are opposite to each other so as to connect the pair of end surfaces 2a and 2b. Here, the direction in which the end surfaces 2a and 2b are opposite to each other is defined as a Y-axis direction (third direction). A direction in which the side surfaces 2c and 2d are opposite to each other is defined as a Z-axis direction (first direction). A direction in which the side surfaces 2e and 2f are opposite to each other is defined as an X-axis direction (second direction). The X-axis direction is a direction orthogonal to the Z-axis direction. The Y-axis direction is a direction orthogonal to the X-axis direction and the Z-axis direction. The end surface 2a is disposed on the positive side in the Y-axis direction, and the end surface 2b is disposed on the negative side. The side surface 2c is disposed on the positive side in the Z-axis direction, and the side surface 2d is disposed on the negative side. The side surface 2e is disposed on the positive side in the X-axis direction, and the side surface 2f is disposed on the negative side.

As illustrated in FIG. 2, the element body 2 is formed by stacking a plurality of insulator layers 11. Each of the insulator layers 11 has a right-angled quadrilateral shape (in the present embodiment, a rectangular shape) and has four sides 11c, 11d, 11e, and 11f that define the side surfaces 2c, 2d, 2e, and 2f. Each of the insulator layers 11 is an insulator having electrical insulation properties, and is formed of a sintered body of an insulator green sheet. In the actual element body 2, the insulator layers 11 are integrated to such an extent that boundaries between the layers cannot be visually recognized.

The insulator layer 11 may be made of ferrite (for example, Ni—Cu—Zn based ferrite, Ni—Cu—Zn—Mg based ferrite, Cu—Zn based ferrite, Ni—Cu based ferrite, or the like).

The size of the element body 2 in the Z-axis direction is defined as a dimension L1. The dimension L1 is a distance between the side surfaces 2c and 2d in the Z-axis direction. The size of the element body 2 in the X-axis direction is defined as a dimension L2. The dimension L2 is a distance between the side surfaces 2e and 2f in the X-axis direction. The size of the element body 2 in the Y-axis direction is defined as a dimension L3 (see FIG. 3). The dimension L3 is a distance between the end surfaces 2a and 2b in the Y-axis direction. The dimension L1 may be 200 μm or more, and may be 250 μm or more. In addition, the dimension L1 may be 450 μm or less, and 300 μm or less. The dimension L2 may be 120 μm or more, and may be 170 μm or more. In addition, the dimension L2 may be 320 μm or less, and may be 210 μm or less. The dimension L3 may be 250 μm or more, and may be 340 μm or more. In addition, the dimension L3 may be 600 μm or less, and may be 380 μm or less. However, the dimensions are not limited to these ranges.

The external electrode 4 is formed so as to cover the entire one end surface 2a and a part of the four side surfaces 2c, 2d, 2e, and 2f. The external electrode 5 is formed so as to cover the entire other end surface 2b and a part of the four side surfaces 2c, 2d, 2e, and 2f. The stacking direction of the plurality of insulator layers 11 coincides with the direction in which the pair of end surfaces 2a and 2b are opposite to each other. Therefore, the pair of external electrodes 4 and 5 are disposed at both end portions of the element body 2 in the stacking direction of the plurality of insulator layers 11. The external electrode 4 is disposed on the positive side in the Y-axis direction. The external electrode 5 is disposed on the negative side in the Y-axis direction.

Each of the external electrodes 4 and 5 is formed by applying a conductive paste containing copper, silver, gold, nickel, chromium, or the like as a main component to the outer surfaces of the element body 2, baking the paste, and further electroplating the outer surfaces. For electroplating, Cu, Ni, Sn, or the like can be used. The conductive paste is applied by, for example, a dipping method, a printing method, or a transfer method. The plating treatment is, for example, electrolytic plating or electroless plating. By this plating treatment, a plating layer is formed on the outer surface of the conductive paste.

As illustrated in FIG. 2, the multilayer coil component 1 includes a plurality of coil patterns 12 and a connection portion 13. The connection portion 13 includes a lead conductor 14 and a connection conductor 15. The plurality of coil patterns 12, the lead conductor 14, and the connection conductor 15 are placed side by side in the stacking direction of the insulator layers 11 in the element body 2. Each of the coil patterns 12, the lead conductor 14, and the connection conductor 15 include a conductive material such as copper, silver, gold, nickel, palladium, or chromium. Each of the coil patterns 12, the lead conductor 14, and the connection conductor 15 are formed as a sintered body of a conductive paste containing the conductive material. Conductor patterns to be the conductors 12, 14, and 15 are formed by screen-printing the conductive paste using screen plates in which openings corresponding to the conductor patterns are formed.

Each of the conductor patterns 21 forming the coil patterns 12 is formed in a substantially U shape. A pad portion 23 having a substantially circular shape and corresponding to a through-hole conductor 22 is formed at each of one end portion and the other end portion of the conductor pattern 21. The conductor patterns 21 are connected in series via the through-hole conductor 22 in a state where the phase of the conductor pattern is shifted by 90 degrees, and form a coil 10 in which a coil axis L (see FIG. 3), which is a central axis, extends along the stacking direction. The coil axis L of the coil 10 extends in the Y-axis direction. Note that the number of windings of the coil 10 is not particularly limited.

A conductor pattern 24 forming the lead conductor 14 includes a pad portion (pad conductor) 26 having a substantially circular shape and corresponding to a through-hole conductor 25. That is, the lead conductor 14 includes the through-hole conductor 25 and the pad portion 26 provided integrally with the through-hole conductor 25. An outer end portion of the lead conductor 14 is exposed to the end surfaces 2a and 2b of the element body 2 in the stacking direction and connected to the external electrodes 4 and 5. The lead conductor 14 is disposed at the center of the insulator layer 11.

A conductor pattern 27 forming the connection conductor 15 is formed linearly so as to connect a position corresponding to one pad portion 23 of the coil pattern 12 and a position corresponding to the pad portion 26 of the lead conductor 14. A pad portion 28 having a substantially circular shape and corresponding to the through-hole conductor 25 is formed coaxially with and substantially in the same shape as the pad portion 26 of the lead conductor 14 at one end portion of the conductor pattern 27, and a pad portion 29 having a substantially circular shape and corresponding to the through-hole conductor 22 is formed coaxially with and substantially in the same shape as the pad portion 23 of the coil pattern 12 at the other end portion of the conductor pattern 27. As illustrated in FIG. 2, the one end portion of the conductor pattern 27 is connected to the other end portion of the lead conductor 14 via the through-hole conductor 25, and the other end portion of the conductor pattern 27 is connected to an end portion of the coil pattern 12 via the through-hole conductor 22.

As illustrated in FIG. 3, the multilayer coil component 1 is mounted on a mounting substrate 100. The mounting substrate 100 includes a substrate 101, conductor layers 102 and 103, and resists 104 and 105. The substrate 101 is a flat plate member that serves as a base member of the mounting substrate 100. The conductor layers 102 and 103 are formed on the surface of the substrate 101 with a conductive material. The conductor layer 102 and the conductor layer 103 are disposed apart from each other in the Y-axis direction. The resists 104 and 105 are insulating layers that cover the surfaces of the conductor layers 102 and 103. The resists 104 and 105 expose the conductor layers 102 and 103. The multilayer coil component 1 is mounted on the mounting substrate 100 with one side surface 2d of the pair of side surfaces 2c and 2d as a mounting surface MF. The external electrode 4 is electrically connected to the conductor layer 102, and the external electrode 5 is electrically connected to the conductor layer 103. The external electrode 4 and the conductor layer 102 are fixed by solder 106. The external electrode 5 and the conductor layer 103 are fixed by solder 107. The multilayer coil component 1 is mounted on the mounting substrate 100 in a state where the coil axis L extends along the surface of the substrate 101.

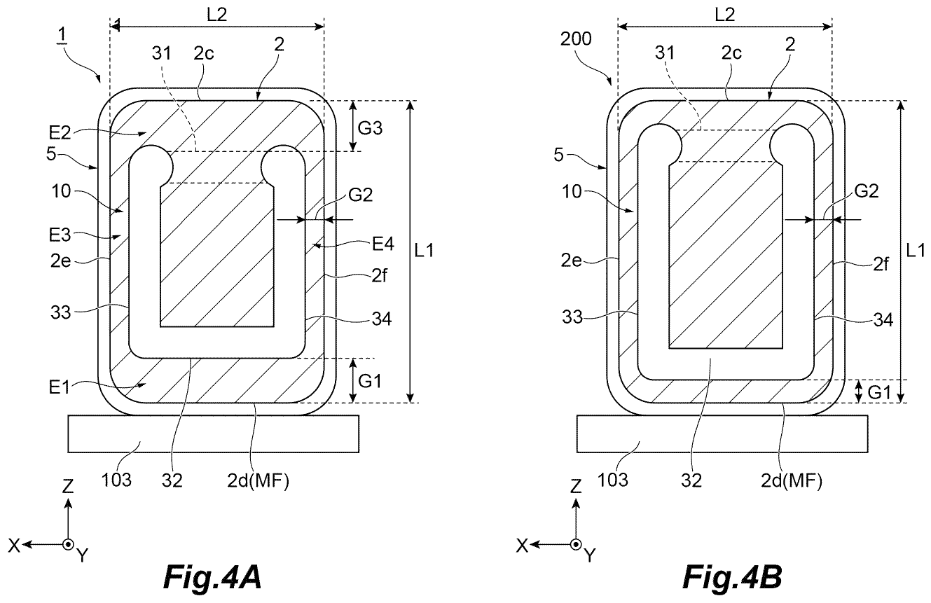

Next, a configuration of the conductor pattern 21 forming the coil pattern 12 will be described in detail with reference to FIG. 4A. As illustrated in FIG. 4A, a cross section of the element body 2 and the coil 10 have a rectangular shape with the Z-axis direction as the longitudinal direction and the X-axis direction as the lateral direction. The coil 10 includes a pair of coil conductors 31 and 32 extending in the X-axis direction, which is the lateral direction, and a pair of coil conductors 33 and 34 extending in the Z-axis direction, which is the longitudinal direction. Note that cross-sectional shapes of the element body 2 and the coil 10 are not particularly limited, and may be a rectangular shape in which the X-axis direction is the longitudinal direction and the Z-axis direction is the lateral direction, or may be a square shape.

The coil conductors 31 and 32 are apart from each other in the Z-axis direction, the coil conductor 31 is disposed on the positive side in the Z-axis direction, and the coil conductor 32 is disposed on the negative side in the Z-axis direction. The coil conductor 31 is disposed at a position apart from the side surface 2c toward the negative side in the Z-axis direction. The coil conductor 32 is disposed at a position apart from the side surface 2d toward the positive side in the Z-axis direction. The coil conductors 33 and 34 are apart from each other in the X-axis direction, the coil conductor 33 is disposed on the positive side in the X-axis direction, and the coil conductor 34 is disposed on the negative side in the X-axis direction. The coil conductor 33 is disposed at a position apart from the side surface 2e toward the negative side in the X-axis direction. The coil conductor 34 is disposed at a position apart from the side surface 2f toward the positive side in the X-axis direction.

End portions of the coil conductor 33 on the positive side and the negative side in the Z-axis direction are connected to end portions of the coil conductors 31 and 32 on the positive side in the X-axis direction. End portions of the coil conductor 34 on the positive side and the negative side in the Z-axis direction are connected to end portions of the coil conductors 31 and 32 on the negative side in the X-axis direction. As a result, the coil conductors 31, 32, 33, and 34 form a rectangular annular shape as viewed in the Y-axis direction. Note that the coil pattern 12 illustrated in FIG. 4A includes the coil conductors 32, 33, and 34, and is opened on the positive side in the Z-axis direction. Regarding the dimensional relationship described below, the same relationship holds for other than the coil pattern 12 illustrated in FIG. 4A.

Next, a dimensional relationship of the multilayer coil component 1 will be described. The size of a gap in the Z-axis direction between the coil 10 and the mounting surface MF in a cross section viewed in the Y-axis direction is defined as a first gap G1. The size of a gap in the X-axis direction between the coil 10 and the side surfaces 2e and 2f in the cross section viewed in the Y-axis direction is defined as a second gap G2. The size of the first gap G1 is a dimension in the Z-axis direction between an edge portion of the coil conductor 32 on the negative side in the Z-axis direction and the side surface 2d. The size of the second gap G2 is a dimension in the X-axis direction between an edge portion of the coil conductor 33 on the positive side in the X-axis direction and the side surface 2e. Alternatively, the size of the second gap G2 is a dimension in the X-axis direction between an edge portion of the coil conductor 34 on the negative side in the X-axis direction and the side surface 2f. Note that the second gap G2 on the coil conductor 33 side and the second gap G2 on the coil conductor 34 side are not necessarily the same, and may be different from each other. In this case, an average value of the second gap on the coil conductor 33 side and the second gap on the coil conductor 34 side is adopted as the second gap G2. Note that when a dimension in the Z-axis direction between an edge portion of the coil conductor 31 on the positive side in the Z-axis direction and the side surface 2c is defined as a third gap G3, the third gap G3 may have the same dimension as the first gap G1. However, the third gap G3 may have a dimension different from that of the first gap G1. The third gap G3 may have the same dimensional condition as the first gap G1 described below. However, a dimensional relationship of the third gap G3 is not particularly limited, and may not have the dimensional condition of the first gap G1.

In the cross section viewed in the Y-axis direction, the first gap G1 in the Z-axis direction between the coil 10 and the mounting surface MF is larger than the second gap G2 in the X-axis direction between the coil 10 and the side surfaces 2e and 2f. Specifically, the first gap G1 may be 1.2 times or more, and may be 1.8 times or more the second gap G2. As a result, a distance for suppressing a crack can be secured between the mounting surface MF, which is distorted by stress, and the coil 10 in the element body 2. The first gap G1 may be 6.0 times or less, and may be 3.0 times or less the second gap G2. As a result, it is possible to suppress a deterioration in inductance characteristics due to a decrease in the inner diameter of the coil. When the upper limit is exceeded, the inner diameter of the coil may be reduced, leading to a deterioration in inductance characteristics.

In the cross section viewed in the Y-axis direction, the ratio of the first gap G1 to the dimension L1, which is the size of the element body 2 in the Z-axis direction, may be 12% or more, and may be 18% or more. As a result, a distance for suppressing a crack can be secured between the mounting surface MF, which is distorted by stress, and the coil 10 in the element body 2. In addition, in the cross section viewed in the Y-axis direction, the ratio of the first gap G1 to the dimension L1, which is the size of the element body 2 in the Z-axis direction, may be 30% or less, and may be 25% or less. As a result, it is possible to suppress a deterioration in inductance characteristics due to a decrease in the inner diameter of the coil. When the upper limit is exceeded, the inner diameter of the coil may be reduced, leading to a deterioration in inductance characteristics.

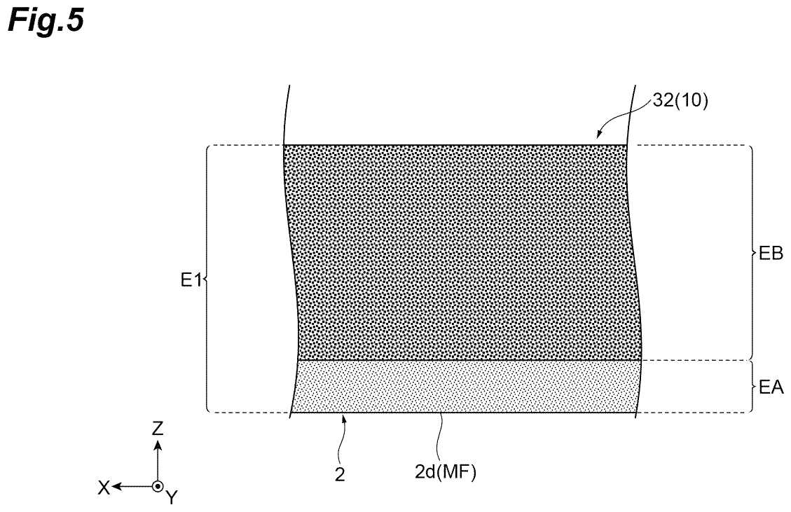

FIG. 5 is an enlarged cross-sectional view of the vicinity of the mounting surface MF as viewed in the Y-axis direction. As illustrated in FIG. 5, in a first region E1 between the mounting surface MF and the coil 10 in the element body 2, a surface layer region EA constituting the mounting surface MF and an internal region EB on the inner side of the surface layer region EA are formed. The surface layer region EA is a region having a predetermined thickness from the side surface 2d toward the positive side in the Z-axis direction. The internal region EB is a region on the positive side of the surface layer region EA in the Z-axis direction. The surface layer region EA and the internal region EB may be formed substantially in the entire region of the element body 2 in the Y-axis direction. The surface layer region EA is a region having a larger average crystal grain size than the internal region EB. Such a surface layer region EA is formed by making the sinterability of the surface layer region EA higher than that of the internal region EB. The ratio of the average crystal grain size of the surface layer region EA to the average crystal grain size of the internal region EB may be in a range of 1.2 to 2.0. Note that the average crystal grain size of the surface layer region EA is not particularly limited, but may be set to 0.5 to 3.0 μm. The thickness of the surface layer region EA is not particularly limited, but may be set to 2 to 8 μm.

The surface layer region EA may be 2% or more, and may be 3% or more of the first region E1. In this case, the surface layer region EA can secure a thickness for suppressing the occurrence of a crack. The surface layer region EA may be 25% or less, and may be 20% or less of the first region E1. Note that the ratio of the surface layer region EA to the first region E1 may be an average value of the ratio of the thickness of the surface layer region EA to the thickness of the first region E1 in the Z-axis direction at each position in the X-axis direction. In this case, it is possible to secure the thickness of the internal region EB sufficient for suppressing the progress of a crack. Note that a second region E2 between the side surface 2c and the coil 10 in the element body 2, a third region E3 between the side surface 2e and the coil 10 in the element body 2, and a fourth region E4 between the side surface 2f and the coil 10 in the element body 2 may have the same layer structure as the first region E1.

Next, functions and effects of the multilayer coil component 1 according to the present embodiment will be described.

The multilayer coil component 1 includes the coil 10 disposed inside the element body 2 and having the coil axis L extending in the Y-axis direction orthogonal to the Z-axis direction and the X-axis direction. In addition, the side surface 2d, which is one of the pair of side surfaces 2c and 2d opposite to each other in the Z-axis direction, is the mounting surface MF. Therefore, the multilayer coil component 1 is mounted in such an arrangement that the coil axis L extends along the surface of the mounting substrate 100 (see FIG. 3). At this time, stress is applied to the mounting surface MF of the multilayer coil component 1 due to the influence of expansion, contraction, and the like of the conductor layers 102 and 103 of the mounting substrate 100.

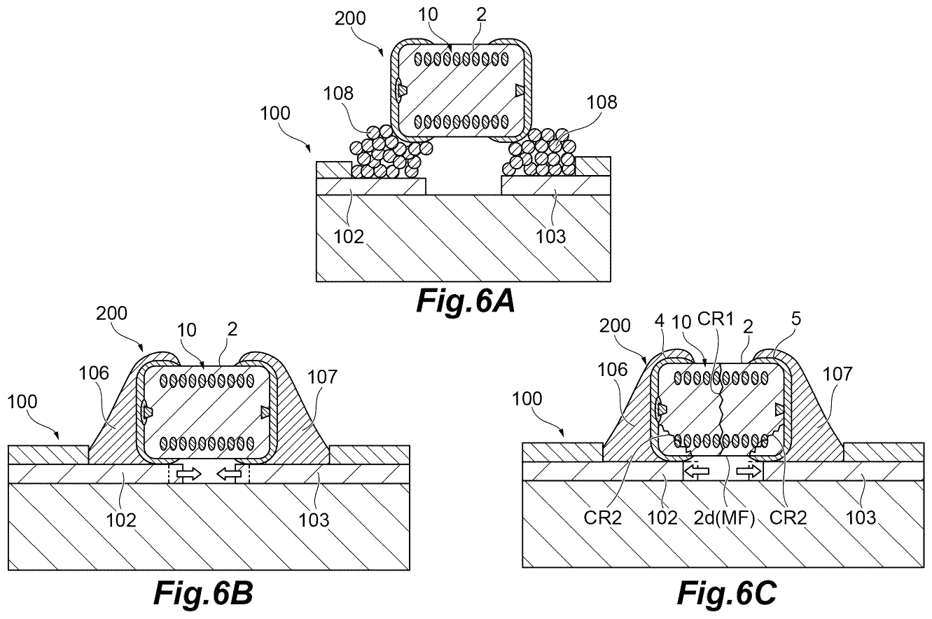

Here, a multilayer coil component 200 according to a comparative example will be described with reference to FIGS. 4B, 6A, 6B, and 6C. As illustrated in FIG. 4B, in the multilayer coil component 200, the first gap G1 is equal to the second gap G2. In addition, the ratio of the first gap G1 to the dimension L1 of the element body 2 is less than 12%. Next, with reference to FIGS. 6A to 6C, a principle in which a crack may occur at the time of mounting the multilayer coil component will be described. First, as illustrated in FIG. 6A, cream solder 108 is applied onto the conductor layers 102 and 103 of the mounting substrate 100. Then, the multilayer coil component 200 is mounted on the conductor layers 102 and 103 via the cream solder 108. Next, as illustrated in FIG. 6B, when solder reflow mounting is performed, the conductor layers 102 and 103 of the mounting substrate 100 expand in a reflow furnace at a high temperature. The conductor layers 102 and 103 expand so as to approach the central position of the element body 2. Next, as illustrated in FIG. 6C, when the reflow is completed and the temperature decreases, the conductor layers 102 and 103 contract so as to move away from the central position of the element body 2. The contraction stress of the conductor layers 102 and 103 applies stress so as to horizontally extend the mounting surface MF of the multilayer coil component 1 mounted via the solders 106 and 107. At this time, when the strength of the element body 2 is insufficient, a crack CR1 occurs in the vertical direction. In addition, a crack CR2 reaching the coil 10 is formed in the vicinity of a corner portion of the element body 2 from an end portion of a wraparound portion of the external electrodes 4 and 5 toward the mounting surface MF side. Note that a mounting procedure as illustrated in FIGS. 6A to 6C is also applied to the multilayer coil component 1 according to the present embodiment.

On the other hand, in the cross section viewed in the Y-axis direction, the ratio of the first gap G1 in the Z-axis direction between the coil 10 and the mounting surface MF to the size of the element body 2 in the Z-axis direction is 12 to 30%. In this case, a distance for suppressing a crack can be secured between the mounting surface MF, which is easily distorted by stress, and the coil 10 in the element body 2. As described above, a crack due to stress at the time of mounting can be suppressed.

In the cross section viewed in the Y-axis direction, the first gap G1 may be larger than the second gap G2 in the X-axis direction between the coil 10 and the side surfaces 2e and 2f. In this case, a distance for suppressing a crack can be secured between the mounting surface MF, which is easily distorted by stress, and the coil 10 in the element body 2.

The first gap G1 may be 1.2 to 6.0 times the second gap G2. In this case, a distance for suppressing a crack can be secured between the mounting surface MF, which is easily distorted by stress, and the coil 10 in the element body 2.

Here, the effect of suppressing a crack by increasing the first gap G1 will be described in more detail. As illustrated in FIG. 3, in an insulator material portion on the outer peripheral side of the coil 10, a region DE1 (illustrated in gray in FIG. 3) having the mounting surface MF is a region that is easily distorted by stress due to expansion and contraction of the conductor layers 102 and 103. Since a distance of the region DE1 in the Z-axis direction is large, the stress acting per unit volume in the region DE1 is reduced. As a result, the occurrence of the cracks CR1 and CR2 (see FIG. 6C) is suppressed. In addition, even if the crack CR2 occurs at the corner portion, the coil pattern 12 of the coil 10 is largely separated from the mounting surface MF, so that it is possible to prevent the crack CR2 from reaching the coil pattern 12 and disconnecting the coil pattern 12. In addition, it is possible to prevent the crack CR2 from blocking a magnetic flux B generated in the coil 10.

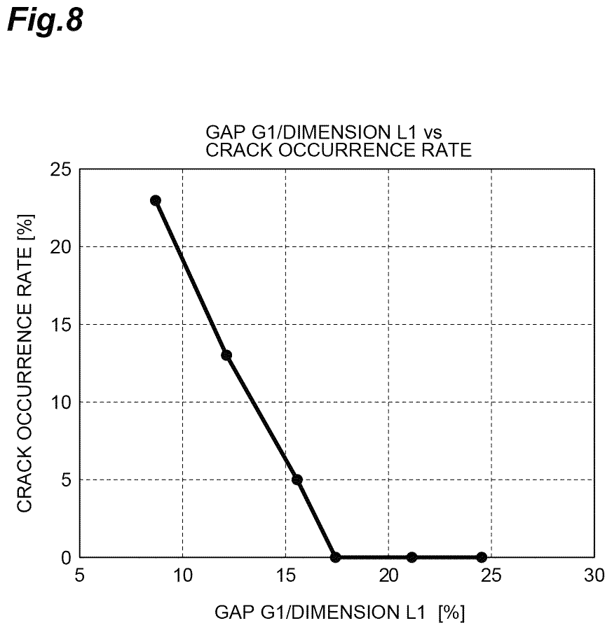

FIG. 8 illustrates a result of an experiment for confirming the effect of increasing the first gap G1. In this experiment, the dimension L1=275 μm, the dimension L2=185 μm, the dimension L3=360 μm, and the gap G2=15 μm. On the other hand, six types of multilayer coil components having different first gaps G1 were prepared. One hundred pieces were prepared for each type and mounted on mounting substrates. When the crack CR1 extending in the vertical direction (see FIG. 6C) could be observed in appearance, it was regarded as “crack occurrence”, and the ratio was calculated. A graph of the calculation result is illustrated in FIG. 8. In FIG. 8, the vertical axis represents the crack occurrence rate, which is the ratio of the number of cracks that occurred in the 100 pieces. The horizontal axis represents the ratio of the gap G1 to the dimension L1. As illustrated in FIG. 8, by setting the ratio of the gap G1 to the dimension L1 to 12% or more, it was possible to confirm the effect of suppressing the crack occurrence. A plot of the ratio “G1/L1=9%”, that is, the leftmost plot in the graph is the conventional structure according to the comparative example. It was possible to confirm that when the ratio was set to 12% or more, the crack occurrence rate (crack occurrence risk) could be suppressed to about half as compared with the comparative example.

In the first region E1 between the mounting surface MF and the coil 10 in the element body 2, the surface layer region EA constituting the mounting surface MF and the internal region EB on the inner side of the surface layer region EA are formed, and the surface layer region EA may have a larger average crystal grain size than the internal region EB. In this case, the occurrence of a crack on the mounting surface MF can be suppressed in the surface layer region EA having a large average crystal grain size. On the other hand, even when a crack occurs on the mounting surface MF, the internal region EB having a small average crystal grain size and having pores can suppress the progress of the crack to the inside.

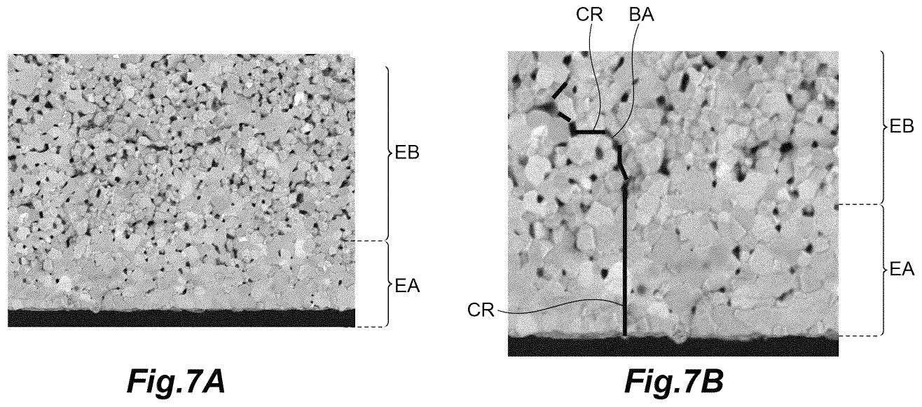

The surface layer region EA may be 2 to 25% of the first region E1. In this case, the effect of suppressing the occurrence of a crack on the mounting surface MF in the surface layer region EA and the effect of suppressing the progress of the crack in the internal region EB can be obtained in a well-balanced manner. FIGS. 7A and 7B illustrate enlarged photographs of the vicinity of the surface layer region EA. As illustrated in FIG. 7B, in the surface layer region EA serving as a starting point of the crack CR, the strength is high because there are few pores BA, and the crack CR is less likely to occur. Even if the crack CR occurs, there are many pores BA in the internal region EB, so that the crack CR does not proceed straight toward the inside but extends in a random direction so as to run between the pores BA. Therefore, the progress of the crack CR is suppressed in the internal region EB.

The present invention is not limited to the above-described embodiment.

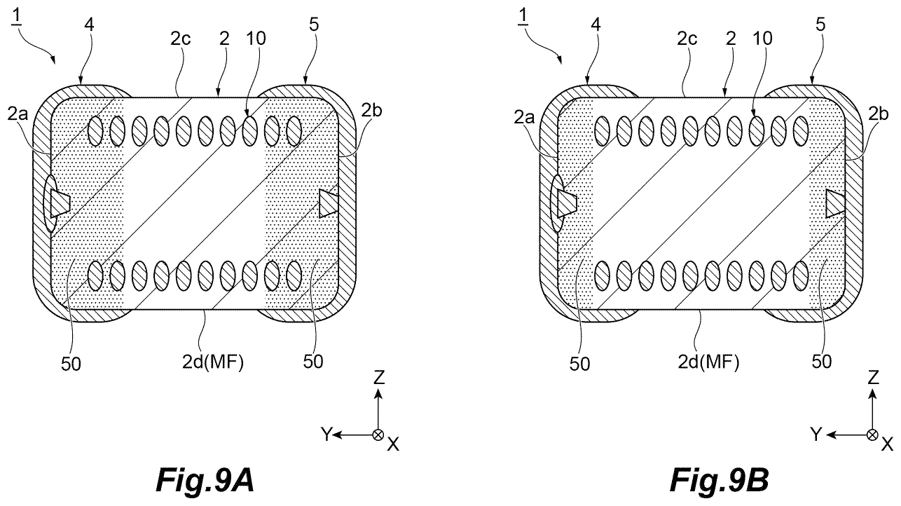

For example, configurations illustrated in FIGS. 9A and 9B may be adopted. As illustrated in FIGS. 9A and 9B, the element body 2 may have buffer portions 50 having a high cushioning property on both sides in the Y-axis direction. The buffer portion 50 is provided at each of places having the end surfaces 2a and 2b in the element body 2. The buffer portion 50 has a structure having a low Young's modulus. A standard portion sandwiched between the pair of buffer portions 50 is a portion whose Young's modulus is set to a standard value of the element body 2, and has a Young's modulus higher than that of the buffer portion 50. The size of the buffer portion 50 is not particularly limited, and the buffer portion 50 may extend to the coil 10 as illustrated in FIG. 9A, or the buffer portion 50 may be formed in a range not extending to the coil 10 as illustrated in FIG. 9B.

### REFERENCE SIGNS LIST

1 MULTILAYER COIL COMPONENT
2 element body
2c, 2d side surface (first side surface)
2e, 2f side surface (second side surface)
10 coil
E1 first region
EA surface layer region
EB internal region
G1 first gap
G2 second gap
MF mounting surface
L central axis

What is claimed is:

1. A multilayer coil component comprising:
an element body having a pair of first side surfaces opposite to each other in a first direction and a pair of second side surfaces opposite to each other in a second direction orthogonal to the first direction; and
a coil disposed inside the element body and having a coil axis extending in a third direction orthogonal to the first direction and the second direction, wherein
one of the pair of first side surfaces is a mounting surface, and
a ratio of a first gap in the first direction between the coil and the mounting surface to a size of the element body in the first direction is 12 to 30% in a cross section viewed in the third direction.

2. The multilayer coil component according to claim 1, wherein the first gap is larger than a second gap in the second direction between the coil and the second side surface in the cross section viewed in the third direction.

3. The multilayer coil component according to claim 2, wherein the first gap is 1.2 to 6.0 times the second gap.

4. The multilayer coil component according to any one of claim 1, wherein
a surface layer region constituting the mounting surface and an internal region on an inner side of the surface layer region are formed in a first region between the mounting surface and the coil in the element body, and
the surface layer region has a larger average crystal grain size than the internal region.

5. The multilayer coil component according to claim 4, wherein the surface layer region is 2 to 25% of the first region.

6. A multilayer coil component comprising:
an element body having a pair of first side surfaces opposite to each other in a first direction and a pair of second side surfaces opposite to each other in a second direction orthogonal to the first direction; and
a coil disposed inside the element body and having a coil axis extending in a third direction orthogonal to the first direction and the second direction, wherein
one of the pair of first side surfaces is a mounting surface, and
a first gap in the first direction between the coil and the mounting surface is larger than a second gap in the second direction between the coil and the second side surface in a cross section viewed in the third direction.

7. The multilayer coil component according to claim 6, wherein the first gap is 1.2 to 6.0 times the second gap.
